(19) United States
(12) Patent Application Publication
(10) Pub. No.: US 2008/0284193 A1
(43) Pub. Date: Nov. 20, 2008

(54) TAILGATE DAMPENER

(75) Inventors: John Gleason, South Lyon, MI (US); William P. Ryan, III, Farmington Hills, MI (US); Daniel Dearing, Royal Oak, MI (US)

Correspondence Address: GIFFORD, KRASS, SPRINKLE,ANDERSON & CITKOWSKI, P.C, PO BOX 7021, TROY, MI, 48007-7021, US

(73) Assignee: Z F Group North American Operations, Inc., Northville, MI (US)

(21) Appl. No.: 12/121,088

(22) Filed: May 15, 2008

Related U.S. Application Data
(60) Provisional application No. 60/938,343, filed on May 16, 2007.

(51) Int. Cl. B60P 1/267

(52) U.S. Cl. 296/50

(57) ABSTRACT

A tailgate damper for damping the lowering of a tailgate that is rotatably coupled along a tailgate shaft to a truck is provided. The tailgate damper can include a housing that has an inner cavity with a viscous fluid within the inner cavity. In addition, a seal can be located at a base of the inner cavity and be operable to keep the viscous fluid therewithin. A damping insert having a damping portion and a tailgate portion extending from the tailgate portion is provided, with the tailgate portion being able to attach coaxially to the tailgate shaft. The damping portion is located at least partially within the inner cavity of the housing and is in contact with the viscous fluid such that rotation of the damping portion is resisted.

### CROSS-REFERENCE TO RELATED APPLICATIONS

This application claims priority of U.S. Provisional Patent Application Ser. No. 60/938,343 filed May 16, 2007, which is incorporated herein by reference.

### FIELD OF THE INVENTION

This invention relates generally to a tailgate damper used for lowering a tailgate of a truck. More specifically, the invention relates to a tailgate damper that is located coaxially with a rotation axis of the tailgate.

### BACKGROUND OF THE INVENTION

Pickup trucks typically have a tailgate that can prevent material, objects, etc. from escaping from a truck bed when it is in the closed position. The tailgate is typically opened using a hand latch which then allows the tailgate to swing or rotate in a downward position and provide horizontal access to the truck bed. Most tailgates have a restraining mechanism which prevents the tailgate from lowering greater than the horizontal position, however these mechanisms do not prevent the tailgate from opening in a freefall fashion and coming to an abrupt stop when the full extended length of the restraining mechanism has been reached. The opening of the tailgate in such a freefall fashion can damage and wear the tailgate and/or the restraining mechanism and thereby require maintenance and/or repair of the tailgate.

Efforts have been made to dampen the lowering of the tailgate from the generally vertical closed position to the generally horizontal open position. However such efforts have used cables and/or hydraulic cylinders that must be located within the sidewalls of the truck bed or within the tailgate itself. Such mechanisms can be difficult to assemble with the vehicle truck and even more so after the vehicle has been provided to a user. As such, an improved tailgate damping mechanism would be desirable.

### SUMMARY OF THE INVENTION

A tailgate damper for damping the lowering of a tailgate that is rotatably coupled along a tailgate shaft to a truck is provided. The tailgate damper can include a housing that has an inner cavity with a viscous fluid therewithin. In addition, a seal can be located at a base of the inner cavity and be operable to keep the viscous fluid from escaping therefrom. A damping insert having a damping portion and a tailgate portion extending from the tailgate portion is provided, with the tailgate portion being able to attach coaxially to the tailgate shaft. The damping portion is located at least partially within the inner cavity of the housing and is in contact with the viscous fluid such that rotation of the damping portion is resisted.

In some instances, the inner cavity is cylindrically shaped and has an inner diameter, the inner cavity including a first fluid cavity and a second fluid cavity separated from each other by a divider wall. The damping portion of the damping insert can have a damping surface that is located within the first and second fluid cavities, the damping surface having an outer edge that is spaced apart from the inner diameter of the housing inner cavity such that a gap is formed therebetween. The gap allows for the viscous fluid to flow from one side of the damping surface to an opposite side of the damping surface when the damping portion rotates. However, the gap is of a dimension such that the flow of the viscous fluid from one side of the damping surface to the opposite side of the damping surface is controlled such that resistance is provided to the rotation of the damping surface. In this manner, the lowering of the tailgate from a generally vertical closed position to a generally horizontal open position is resisted. In addition, a one-way valve can be located within the inner cavity such that the flow of the viscous fluid is enhanced when the tailgate, and thus the damping surface coupled thereto, is rotated the open position to the closed position.

In other instances, the damping portion can include a torsional spring that has a first end and a second end, the first end being attached to the damping insert and the second end attached to the housing, and/or a set of shear plates in contact with the viscous fluid that resist rotation of the tailgate when moving from the closed position to the open position.

### BRIEF DESCRIPTION OF THE DRAWINGS

FIG. 1 is a side view of a pickup truck illustrating a tailgate being lowered from a closed generally vertical position to an open generally horizontal position;

FIG. 2 is a perspective view of an embodiment of the present invention;

FIG. 3 is an exploded perspective view of the embodiment shown in FIG. 2;

FIG. 4 is an end view of a housing for the embodiment shown in FIG. 3;

FIG. 5 is an end view of a damping insert for the embodiment shown in FIG. 3;

FIG. 6 is an end cross-sectional view of the embodiment shown in FIG. 2 wherein a tailgate is in a closed position;

FIG. 6A is an enlarged view of the circled region 6A shown in FIG. 6;

FIG. 7 is an end cross-sectional view of the embodiment shown in FIG. 2 wherein a tailgate is in an open position;

FIG. 8 is an end cross-sectional view of the embodiment shown in FIG. 2 wherein a tailgate is being raised from an open position to a closed position;

FIG. 9 is a side cross-sectional view of section 9-9 shown in FIG. 10 of a second embodiment of the present invention; and

FIG. 10 is an end cross-sectional view of section 10-10 shown in FIG. 9.

### DETAILED DESCRIPTION OF THE INVENTION

The present invention discloses a tailgate damper that damps the lowering of a tailgate from a generally vertical closed position to a generally horizontal open position. As such, the tailgate damper has utility as a motor vehicle component.

The tailgate damper can include a housing that has an inner cavity with a viscous fluid within the inner cavity. A seal is located at a base of the inner cavity such that the viscous fluid is prevented from leaking or escaping from the inner cavity therefrom. In addition to the housing, a damping insert is provided, the damping insert having a damping portion and a tailgate portion that extends from the damping portion. The tailgate portion can be fixedly attached to a tailgate shaft. In some instances, the tailgate portion is coaxially attached to the tailgate shaft. The damping portion is located at least partially within the inner cavity of the housing and is in contact with the viscous fluid. Contact of the damping portion with the viscous fluid results in resistance to the rotation of the damping portion and thereby resistance to the lowering of the tailgate when it is attached to the tailgate damper.

In some instances, the inner cavity of the housing can be cylindrically shaped and have an inner diameter. In addition, the damping portion can have a damping surface with an outer edge that is spaced apart from an inner surface of the inner cavity, thereby providing a gap therebetween. The gap between the outer edge of the damping surface and the inner surface of the cylindrically shaped inner cavity affords for the viscous fluid to pass from one side of the damping surface to an opposite side of the damping surface. However, the gap is dimensioned such that the flow of the viscous fluid is controlled and rotation of the damping surface is resisted. The inner cavity can also include at least one one-way valve that affords for enhanced flow of the viscous fluid from one side of the damping surface to an opposite side of the damping surface. In the alternative, the inner cavity can be divided into a first fluid cavity and a second fluid cavity by a divider wall. The divider wall can have the one-way valve therewithin and thereby afford for enhanced fluid flow from the first fluid cavity to the second fluid cavity or vice versa.

In some instances, the damping portion can have a shaft with a separation plate extending radially from the shaft. In addition, a torsional spring having a first end and a second end can be located generally parallel to the separation plate, the torsional spring having the first end attached to the damping portion and the second end attached to the housing. The torsional spring can afford for damping of the lowering of the tailgate and assist in the raising of the tailgate. Shear plates can be included in the inner cavity such that rotation of the shear plates within the viscous fluid affords for additional damping of the lowering of the tailgate.

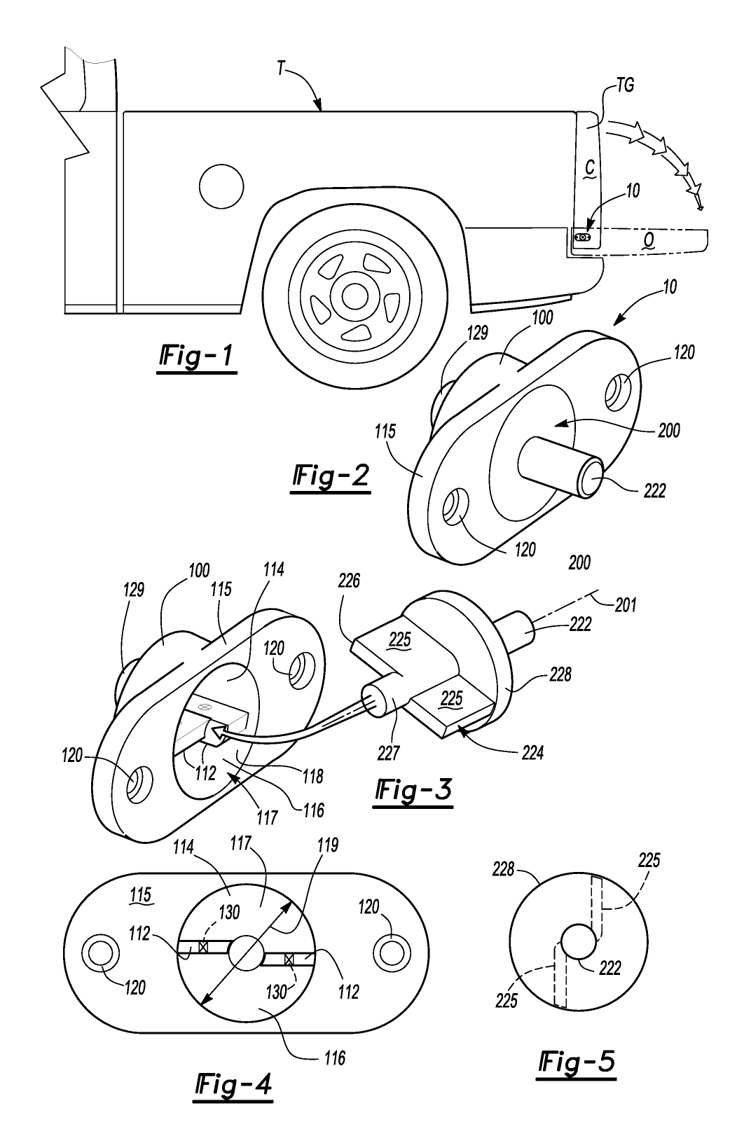

Turning now to FIG. 1, a side view of a portion of a pickup truck T is shown with a tailgate TG illustrated as having been rotated from a generally vertical closed position C to a generally horizontal open position O. Also illustrated in FIG. 1 is an embodiment of a tailgate damper as shown at reference numeral 10.

Turning now to FIGS. 2 and 3, a perspective view of the tailgate damper 10 is shown, the tailgate damper 10 having a housing 100 and a damping insert 200. The housing 100 can have a base plate 115, the base plate 115 having at least one aperture 120 that affords for the attachment of the damper 10 to a truck body of the truck T. In addition, the housing 100 can have an inner cavity 117 with an inner surface 118. The inner cavity 117 can be cylindrically shaped and have an inner diameter 119 as shown in FIG. 4.

The damping insert 200 can have a tailgate portion 222 and a damping portion 224 extending from the tailgate portion 222. In some instances, the tailgate portion 222 can be a shaft that is operable to be fixedly attached to a tailgate shaft of the tailgate, about which the tailgate rotates from the closed position to the open position and vice versa. The damping portion 224 can include a damping surface 225 that fits at least partially within the inner cavity 117 of the housing 100. In addition, a support shaft 227 can extend from the damping surface 225 and be located within a shaft recess 129 of the housing 100 when the damper 10 is assembled. It is appreciated that a bearing (not shown) can be located between the support shaft 227 and the shaft recess 129 and thus provided improved movement therebetween.

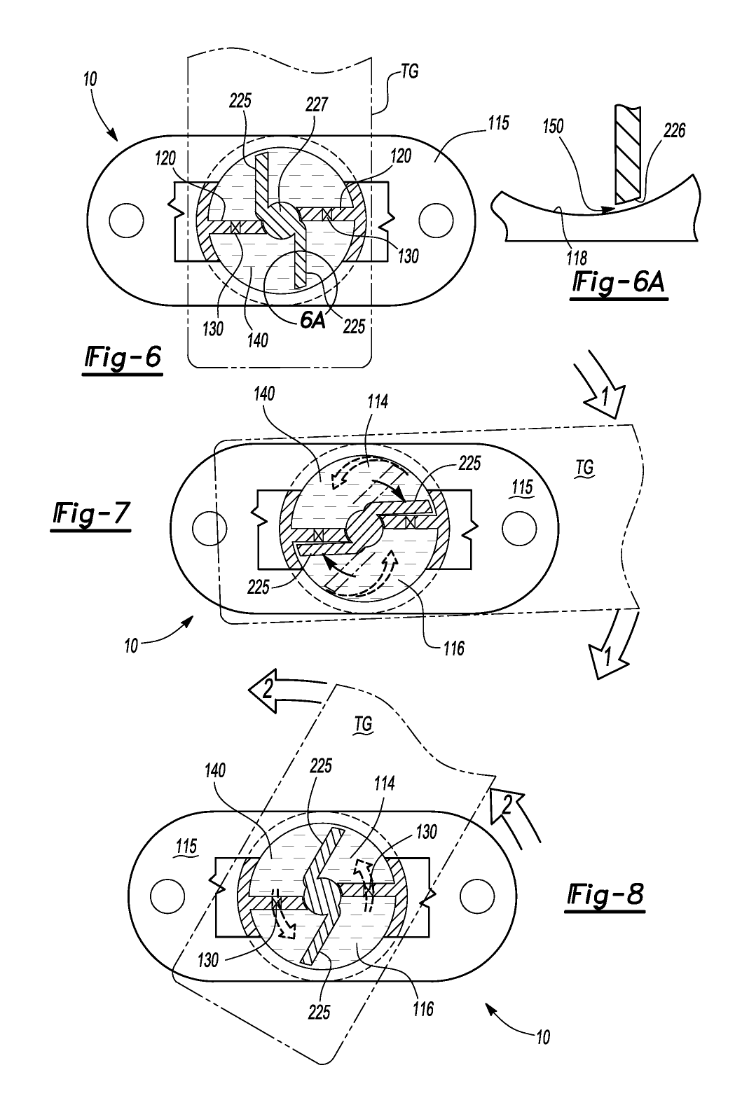

Referring now to FIGS. 6-8, the inner cavity 117 has a viscous fluid 140 contained therein. A seal is provided that prevents the viscous fluid 140 from escaping the inner cavity 117. In some instances, the seal can be a sealing plate 228 of the damping insert 200. In the alternative, the seal can be a separate sealing member (not shown) known to those skilled in the art with the tailgate portion 222 extending therethrough. The damping surface 225 is in contact with the viscous fluid 140 with the rotation of the damping surface 225 resisted by the fluid 140. In some instances, the damping surface 225 can have an outer edge 226 that is spaced apart from the inner surface 118 of the inner cavity 117 when the damping insert 200 is placed within and/or assembled with the housing 100. The distance between the outer edge 226 and the inner surface 118 provides a gap 150 that allows the viscous fluid 140 to flow therebetween, but in a controlled manner. Thus the damping surface 225 is allowed to rotate within the inner cavity 117, however resistance to the rotation is provided by the viscous fluid 140 passing through the gap 150 between the outer edge 226 and the inner surface 118.

In some instances, the inner cavity 117 can be divided into a first fluid cavity 114 and a second fluid cavity 116 by a divider wall 112. The divider wall 112 can have a one-way valve 130 therewithin. With the divider wall 112 present within the inner cavity 117, the damping surface 225 can be located within the first fluid cavity 114 and the second fluid cavity 116 as illustrated in FIGS. 6-8. In addition, the damping surface 225 can be offset about the support shaft 227 such that a complete 90° rotation of the damping insert 200 is afforded. Looking specifically at FIG. 6, an end cross-sectional view of the tailgate damper 10 is provided with the tailgate TG shown in the generally vertical closed position. In addition, the viscous fluid 140 is shown to be present in the first fluid cavity 114 and the second fluid cavity 116. Looking at FIG. 7, as the tailgate TG is rotated in a first direction 1 from the close position to the open position, the viscous fluid 140 flows from one side of the damping surface 225 to an opposite side of the damping surface through the gap 150 as illustrated by the dotted arrows. Thus the damping surface 225 is allowed to rotate but is also resisted by the flow of the viscous fluid 140 through the gap 150.

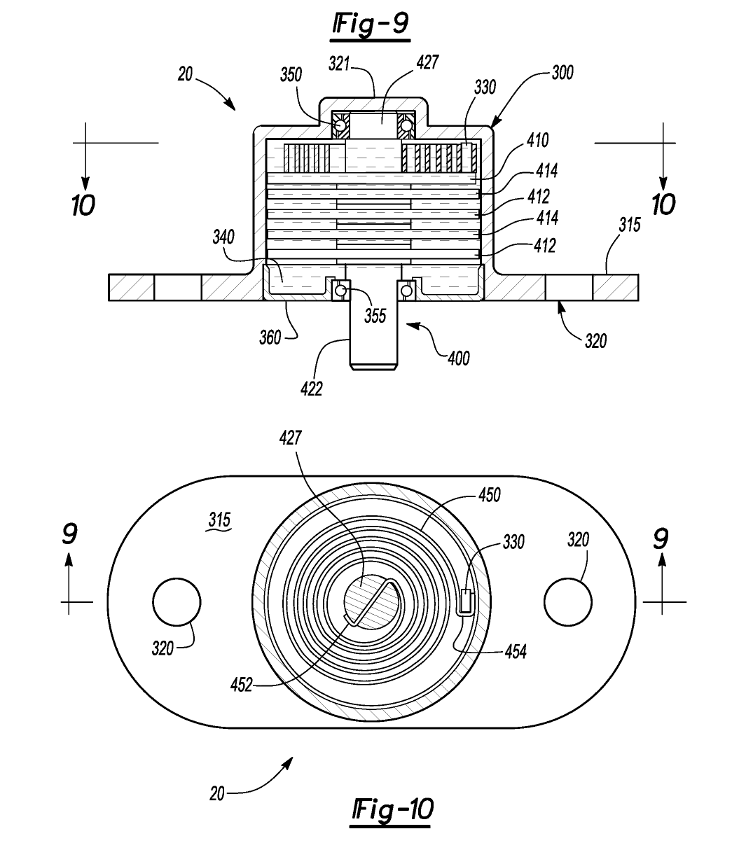

Looking now at FIG. 8, the tailgate TG is illustratively shown as rotating in a second direction 2 such as would occur upon raising the tailgate from the open position to the closed position. In this circumstance, the one-way valve 130 affords for flow of the viscous fluid 140 from the first fluid cavity 114 to the second fluid cavity 116, and vice versa, as illustrated by the dotted arrows. In this manner, the tailgate TG is allowed to be raised from the open position to the closed position without the resistance experienced upon lowering the tailgate from the closed position to the open position. It is appreciated that the one-way valve 130 can be located within the damping surface 225 instead of the divider wall 112 and that more than one one-way valve 130 can be included.

Turning now to FIGS. 9 and 10, another embodiment is shown generally at reference numeral 20. The tailgate damper 20 includes a housing 300 and a damping insert 400. However, instead of a damping surface, a torsional spring 450 and/or a set of shear plates 412 can be included. The torsional spring 450 has a first end 452 and a second 454, the first end 452 being attached to the damping insert 400 and the second end 454 being attached to the housing 300. In some instances, the first end 452 can be attached to a support shaft 427 of the damping insert 400 and the second end 454 can be attached to a tab 330 of the housing 300. It is appreciated that which ends of the torsion spring 450 that are attached to the damping insert 400 and housing 300 is not critical, so long as rotation of the damping insert 400 affords for the winding of the spring 450. It is further appreciated that a viscous fluid 340 may or may not be in contact with the torsion spring 450 and a separation plate 410 can be provided that may or may not separate the viscous fluid 340 from the torsion spring 450.

Shear plates can be included with the first set 412 being fixedly attached to the damping insert 400 and a second set 414 being rotatably attached to the damping insert 400. The second set 414 of the shear plates is shaped such that a notch, tab or the like (not shown) extending from the inner surface of the inner cavity of the housing 300 prevents the rotation of the shear plates 414 when the damping insert 400 is rotated. In contrast, the first set of shear plates 412 being fixedly attached to the damping insert 400, rotate when the insert 400 rotates. It is appreciated that a surface of the first set shear plates 412 and/or the second set of shear plates 414 that is in contact with the viscous fluid 340 can have any configuration which may enhance the resistance of the rotation of the first set of shear plates 412, illustratively including a generally rough surface, a dimpled surface, a surface with polygonal shaped indentations and the like. In this manner, a viscous fluid between the first set of shear plates 412 and the second set of shear plates 414 provides resistance to the rotation of the damping insert 400.

It is appreciated that the damping insert 400 can have a support shaft 427 that extends into a shaft recess 321. In addition, a bearing 350 can be located between the shaft recess 321 and the support shaft 427 in order to provide smooth rotation therebetween.

In operation, the damping insert is attached to the truck body using the base plate and the tailgate shaft portion is attached to the tailgate shaft about which the tailgate rotates. When the tailgate is lowered from the closed position to the open position, the damping portion of the damping insert encounters resistance by either the damping surface being in contact with a viscous fluid within the inner cavity, the winding of the torsion spring as the tailgate is lowered and/or the rotation of the shear plates within the viscous fluid. In this manner, lowering of the tailgate from the closed position to the open position is resisted and the tailgate is prevented from opening in a freefall fashion and coming to an abrupt stop at the generally horizontal open position. In addition, when the tailgate is raised from the open position to the closed position, a one-way valve can be incorporated within the inner cavity such that resistance of the damping portion being rotated in the opposite direction is not present, or is present to a much lesser degree. Likewise, winding of the torsion spring when the tailgate is lowered to the open position can provide assistance to raising the tailgate to the closed position. In this manner, a tailgate damper for damping the lowering of a truck tailgate is provided.

The invention is not restricted to the illustrative examples and/or embodiments described above. The examples and/or embodiments are not intended as limitations on the scope of the invention. Methods, apparatus, compositions and the like described herein are exemplary and not intended as limitations on the scope of the invention. Changes therein and other uses will occur to those skilled in the art. The scope of the invention is defined by the scope of the claims.

We claim:

1. A tailgate damper for damping the lowering of a tailgate that is rotatably coupled to a truck, said tailgate damper comprising:
a housing, said housing having a cylindrically shaped inner cavity with an inner diameter;
a viscous fluid within said inner cavity;
a seal located at a base of said inner cavity, said seal operable to keep said viscous fluid within said inner cavity;
a damping insert having a damping portion and a tailgate portion extending from said damping portion;
said tailgate portion fixedly attachable to the tailgate;
said damping portion located at least partially within said inner cavity and in contact with said viscous fluid with rotation of said damping portion resisted by said viscous fluid, for the purpose of damping the lowering of the tailgate.

2. The tailgate damper of claim 1, wherein said inner cavity of said housing has a first fluid cavity and a second fluid cavity separated from said first fluid cavity by a divider wall.

3. The tailgate damper of claim 2, wherein said damping portion of said damping insert has a damping surface located within said first and second fluid cavities.

4. The tailgate damper of claim 3, wherein said damping surface has an outer edge spaced apart from said inner diameter of said housing inner cavity forming a gap, said gap operable to allow said viscous fluid to flow from one side of said damping surface to an opposite side of said damping surface when said damping portion rotates.

5. The tailgate damper of claim 4, wherein said damping surface has a support shaft extending therefrom along a damping insert axis, said support shaft oppositely disposed from said tailgate shaft.

6. The tailgate damper of claim 5, wherein said housing has a shaft recess wherein said support shaft is at least partially therein.

7. The tailgate damper of claim 6, further comprising a bearing located between said support shaft and said shaft recess.

8. The tailgate damper of claim 1, wherein said damping portion has a shaft plate integral to and extending radially from a damping portion shaft.

9. The tailgate damper of claim 8, further comprising a shear plate spaced apart from and generally parallel to said shaft plate, said shear plate extending radially from said damping portion shaft.

10. The tailgate damper of claim 8, further comprising a plurality of shear plates spaced apart from each other and generally parallel to said shaft plate, said plurality of shear plates extending radially from said damping portion shaft.

11. The tailgate damper of claim 10, further comprising a torsional spring having a first end and a second end, said first end attached to said shaft plate and said second shaft attached to said housing.

12. A tailgate damper for damping the lowering of a tailgate that is rotatably coupled to a truck body from a generally vertical closed position to a generally horizontal open position, said tailgate damper comprising:
a cylindrically shaped housing, said housing having an inner cavity with an inner diameter and a base plate for fixedly attaching said housing to the truck body;
a viscous fluid within said housing inner cavity;
a seal located at a base of said inner cavity, said seal operable to keep said viscous fluid within said housing inner cavity;
a damping insert having a damping portion and a tailgate shaft portion extending from said damping portion;
said tailgate shaft portion fixedly attachable to the tailgate;
said damping portion having a damping surface located at least partially within said housing and in contact with said viscous fluid, said damping surface having an outer edge spaced apart from said inner diameter of said housing inner cavity forming a gap, said gap operable to allow said viscous fluid to flow from one side of said damping surface to an opposite side of said damping surface when said damping portion rotates and thereby damp the lowering of the tailgate that is rotatably coupled to the truck body from the closed position to the open position.

13. The tailgate damper of claim 12, wherein said inner cavity of said housing has a first fluid cavity and a second fluid cavity separated from said first fluid cavity by a divider wall.

14. The tailgate damper of claim 13, wherein said damping surface is located within said first and second fluid cavities.

15. The tailgate damper of claim 13, wherein said damping surface has an outer edge spaced apart from said inner diameter of said housing inner cavity forming a gap, said gap operable to allow said viscous fluid to flow from one side of said damping surface to an opposite side of said damping surface when said damping portion rotates.

16. The tailgate damper of claim 15, wherein said damping surface has a support shaft extending therefrom along a damping insert axis, said support shaft oppositely disposed from said tailgate shaft.

17. The tailgate damper of claim 16, wherein said housing has a shaft recess wherein said support shaft is at least partially therein.

18. The tailgate damper of claim 17, further comprising a bearing located between said support shaft and said shaft recess.

19. A tailgate damper for damping the lowering of a tailgate that is rotatably coupled to a truck body from a generally vertical closed position to a generally horizontal open position, said tailgate damper comprising:
a cylindrically shaped housing, said housing having an inner cavity with an inner diameter and a base plate for fixedly attaching said housing to the truck body;
a viscous fluid within said housing inner cavity;
a seal located at a base of said inner cavity, said seal operable to keep said viscous fluid within said housing inner cavity;
a damping insert located at least partially in said inner cavity of said housing and extending through said seal, said damping insert having a damping portion and a tailgate shaft portion extending from said damping portion;
said tailgate shaft portion fixedly attachable to the tailgate;
said damping portion located within said inner cavity of said housing and having a shaft plate extending radially from a damping portion shaft and a shear plate spaced apart from said shaft plate and extending radially from said damping portion shaft.
